(19) United States
(12) Patent Application Publication
(10) Pub. No.: US 2015/0319608 A1
(43) Pub. Date: Nov. 5, 2015

(54) Method For Detecting Smart Device Use While Operating A Motor Vehicle

(71) Applicant: DENSO INTERNATIONAL AMERICA, INC., Southfield, MI (US)

(72) Inventors: Sibu VARUGHESE, Sterling Heights, MI (US); Martin NESPOLO, Grosse Pointe Woods, MI (US); Kyle GOLSCH, Pontiac, MI (US)

(21) Appl. No.: 14/672,417

(22) Filed: Mar. 30, 2015

Related U.S. Application Data
(60) Provisional application No. 61/986,491, filed on Apr. 30, 2014.

(51) Int. Cl. H04W 8/22; H04W 4/04

(52) U.S. Cl. CPC H04W 8/22; H04W 4/046

(57) ABSTRACT

A method for detecting possession of a smart device by a driver of a vehicle. The method includes the following: detecting with the smart device at least one of a landmark or signal accessible from an interior of the vehicle; analyzing the landmark or signal and the location of the smart device relative thereto to determine whether the smart device is at a driving location of the vehicle; and configuring the smart device in a driving mode if the smart device is at the driving location of the vehicle.

### CROSS-REFERENCE TO RELATED APPLICATION

This application claims the benefit of U.S. Provisional Patent application No. 61/986,491 filed on Apr. 30, 2014, the entire disclosure of which is incorporated herein by reference.

### FIELD

The present disclosure relates to methods and devices for detecting smart device use by an operator of a motor vehicle.

### BACKGROUND

This section provides background information related to the present disclosure, which is not necessarily prior art.

Young drivers report the highest level of smart device use during automobile accidents and near accidents. Young drivers often inappropriately prioritize smart device operation over safety when operating a vehicle. Methods, systems, and devices for improving the safe and lawful operation of a smart device while operating a motor vehicle would therefore be desirable.

### SUMMARY

This section provides a general summary of the disclosure, and is not a comprehensive disclosure of its full scope or all of its features.

The present teachings provide for a method for detecting possession of a smart device by a driver of a vehicle. The method includes: detecting with the smart device at least one of a landmark or signal accessible from an interior of the vehicle; analyzing the landmark or signal and the location of the smart device relative thereto to determine whether the smart device is at a driving location of the vehicle; and configuring the smart device in a driving mode if the smart device is at the driving location of the vehicle.

The present teachings further provide for a system for detecting location of a smart device at a driving location of a vehicle. The system includes at least one detection device of the smart device configured to detect at least one of a landmark or signal accessible from an interior of the vehicle. The system also includes a control unit configured to analyze the landmark or signal and identify location of the smart device relative thereto to determine whether the smart device is at the driving location of the vehicle. The smart device is configured to operate in a driving mode when the smart device is at the driving location of the vehicle.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 illustrates an exemplary smart device according to the present teachings;

FIG. 2 illustrates an exemplary method for operating a smart device according to the present teachings;

FIG. 3 illustrates exemplary use of the smart device of FIG. 1 to determine whether the user is operating a vehicle;

FIG. 4 illustrates another exemplary use of the smart device of FIG. 1 to determine whether the user is operating a vehicle; and

FIG. 5 illustrates yet another exemplary use of the smart device of FIG. 1 to determine whether the user is operating a vehicle.

Corresponding reference numerals indicate corresponding parts throughout the several views of the drawings.

### DETAILED DESCRIPTION

Example embodiments will now be described more fully with reference to the accompanying drawings.

With initial reference to FIG. 1, a smart device according to the present teachings is generally illustrated at reference numeral 10. Although the smart device 10 is illustrated as a smart phone and described herein as a smart phone, the smart device 10 can be any suitable smart device or computing device in general. For example, in addition to a smart phone the smart device 10 can be a tablet computer, a laptop computer, a smart watch, smart glasses, etc.

The smart device 10 generally includes a controller 12, a display 14, and a plurality of sensors. Any suitable sensor or sensors can be included, such as but not limited to one or more of the following: a rear camera 20; a front camera 22; an audio sensor 24; one or more position or motion sensors 26; and/or an antenna 28. The rear and front cameras 20 and 22 can be any suitable cameras configured to sense objects and/or persons proximate to the smart device 10. For example, each one of the rear and front cameras 20 and 22 can be one or more of visible light cameras, infrared cameras, thermal imaging cameras, etc.

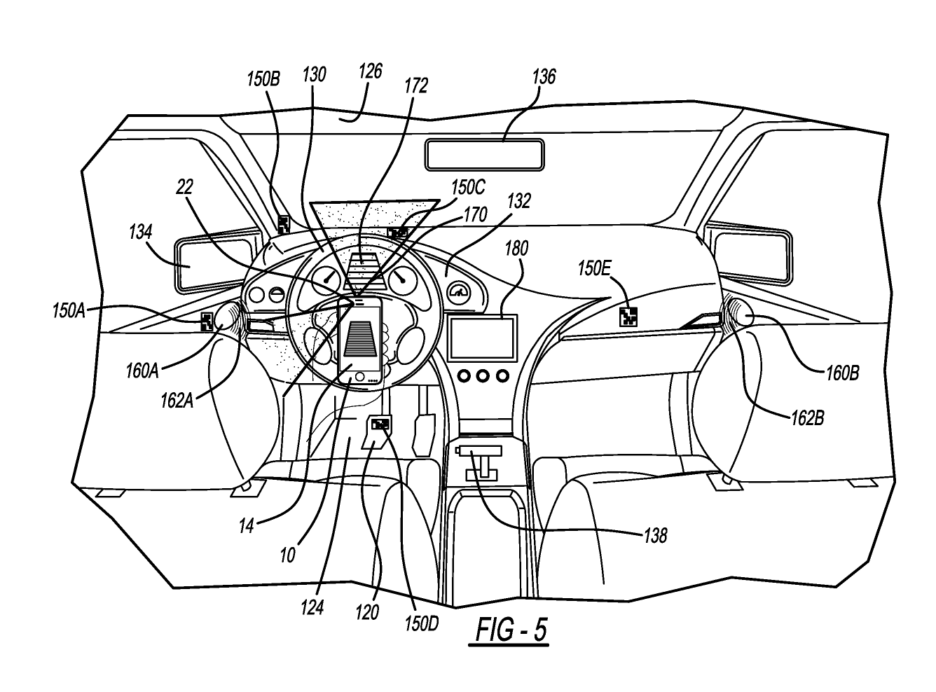

The audio sensor 24 can be any suitable audio sensor, such as a microphone. As described herein, the audio sensor 24 is configured to detect audio emanating from vehicle audio speakers (illustrated in FIG. 5 at reference numbers 160A and 160B). The position sensor 26 can be any suitable sensor or sensors configured to detect position and/or movement of the smart device 10. For example, the position sensor 26 can include one or more of the following: a GPS sensor, a gyroscope, an accelerometer, or any other suitable motion sensor. The antenna 28 can be one or more suitable antennas, such as a WiFi antenna, a Bluetooth antenna, and/or a near field communication antenna (NFC).

The controller 12 can be any suitable controller configured to control operation of the smart device 10. For example, the controller 12 can include any suitable storage device and any suitable processor configured to run or execute an operating system and applications stored on the storage device. As one skilled in the art will appreciate, some operating systems and/or applications can be run in a standard mode of operation or a vehicle mode. In the vehicle mode, the application is optimized for safe and easy use while operating a vehicle. For example, in the vehicle mode the application often displays on the display 14 larger icons, a larger typeface, a more readily legible typeface, and/or may have limited functionality to facilitate safe operation while driving. In the vehicle mode the application may be configured in any manner that will help the driver improve awareness of his/her surroundings, as well as increase eyes-on-road behavior. Although the vehicle is generally described herein as a passenger automobile, the present teachings apply to any suitable vehicle in any suitable form. For example, the present teachings include, but are not limited to, vehicles in the form of a car, truck, sport utility vehicle (SUV), military vehicle, bus, aircraft, train, etc.

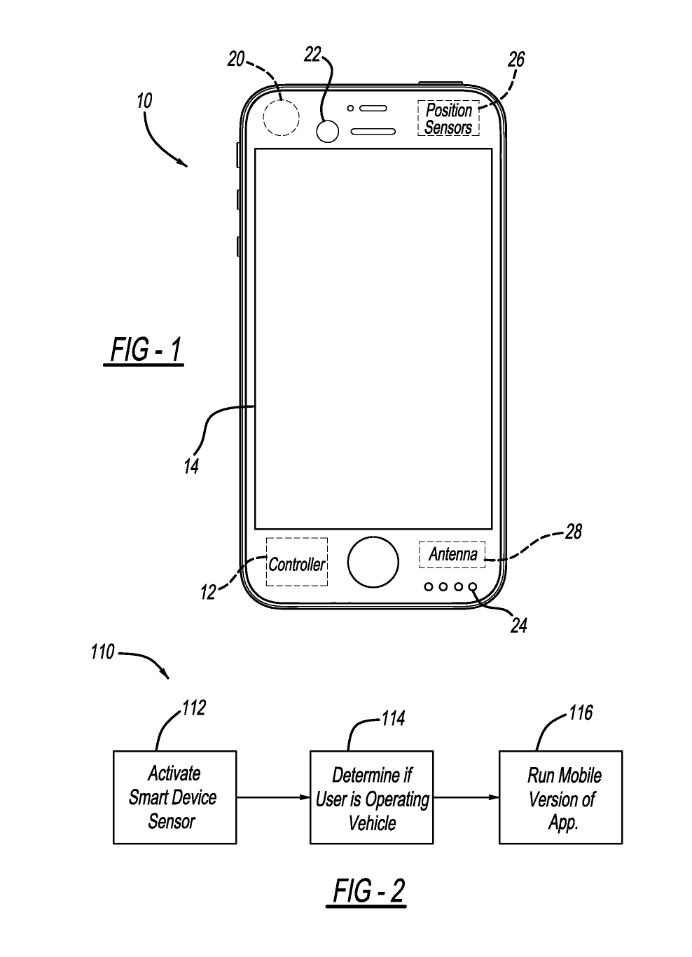

With continued reference to FIG. 1 and additional reference to FIG. 2, a method 110 for operating the smart device 10 will now be described. With initial reference to block 112, the sensors of the smart device 10 are activated, such as the rear camera 20, the front camera 22, the audio sensor 24, the position sensors 26, and/or any other suitable position sensors or other sensors configured to determine location of the smart device 10. Any one or more of these sensors can be continuously active, or can be activated when predetermined conditions are present.

For example, any one or more of the rear camera 20, the front camera 22, and/or the audio sensor 24, can be activated when any other previously activated sensor(s) determines that the user of the smart device 10 is within a vehicle. The sensors can determine that the user of the smart device 10 is within the vehicle in any suitable manner. For example, if the antenna 28 connects to a system of the vehicle, such as a Bluetooth or WiFi system, the controller 12 will determine that the smart device 10 is within a vehicle and activate one of more of the rear camera 20, the front camera 22, and/or the audio sensor 24. The controller 12 can also determine that the smart device 10 is in a vehicle based on movement and/or location of the smart device 10 as detected by one or more of the position sensors 26. For example, if the position sensors 26 determine based on GPS data and/or acceleration data that the smart device 10 is located on a road and/or traveling at a high rate of speed (such as greater than 25 mph), then the controller 12 will determine that the smart device 10 is located within a vehicle and activate one or more of the rear camera 20, the front camera 22, and/or the audio sensor 24.

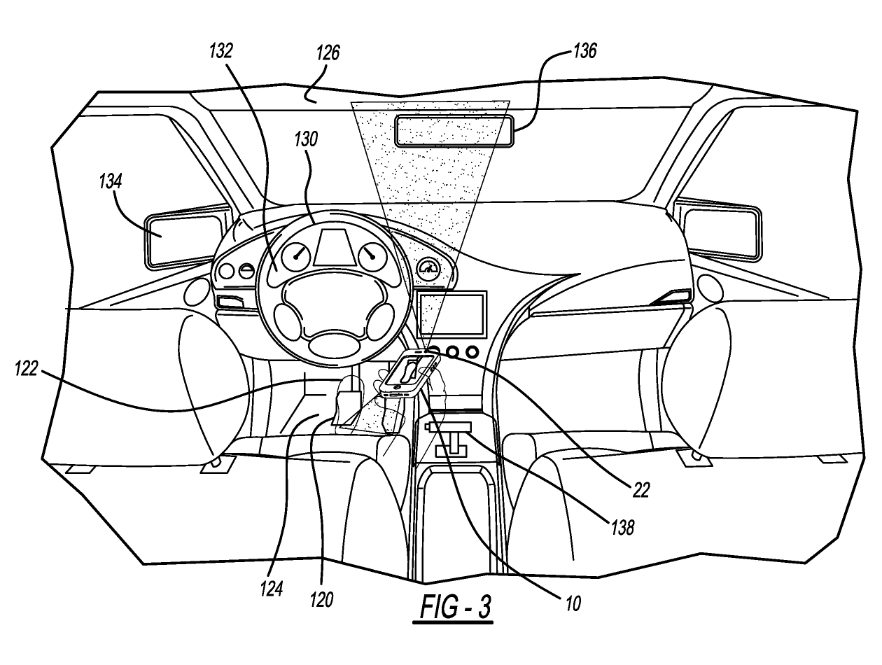

After activating one or more of the sensors at block 112, at block 114 the controller 12 will use the sensors to determine if the user is operating a vehicle or, for example, is merely a passenger in a vehicle. This can be accomplished in any suitable manner. For example and with reference to FIG. 3, if the user is holding the smart device 10 such that the rear camera 20 is generally facing a floor of the vehicle and the front camera 22 is generally facing a ceiling of the vehicle, the controller 12 can compare the images sensed by the cameras 20 and 22 to stock images of various vehicles, or can analyze the images in any suitable manner to identify if the user is seated in the driver's seat, and thereby deemed to be a driver, or at some position within the vehicle. Thus if the rear camera 20 captures one or more images unique to the driver's seat, such as vehicle operating pedals 120, the user's leg and/or foot 122 extending to one or more of the pedals 120, or a shape of a floor mat or carpeting 124 unique to the driver's side, for example, the controller 12 will determine that the smart device 10 is being used by a driver. If the front camera 22 captures one or more images of vehicle ceiling 126 unique to the driver's seat, such as sunroof controls to a right of the user and/or a roof handle to a left of the user, then the controller will determine that the smart device 10 is being used by a driver.

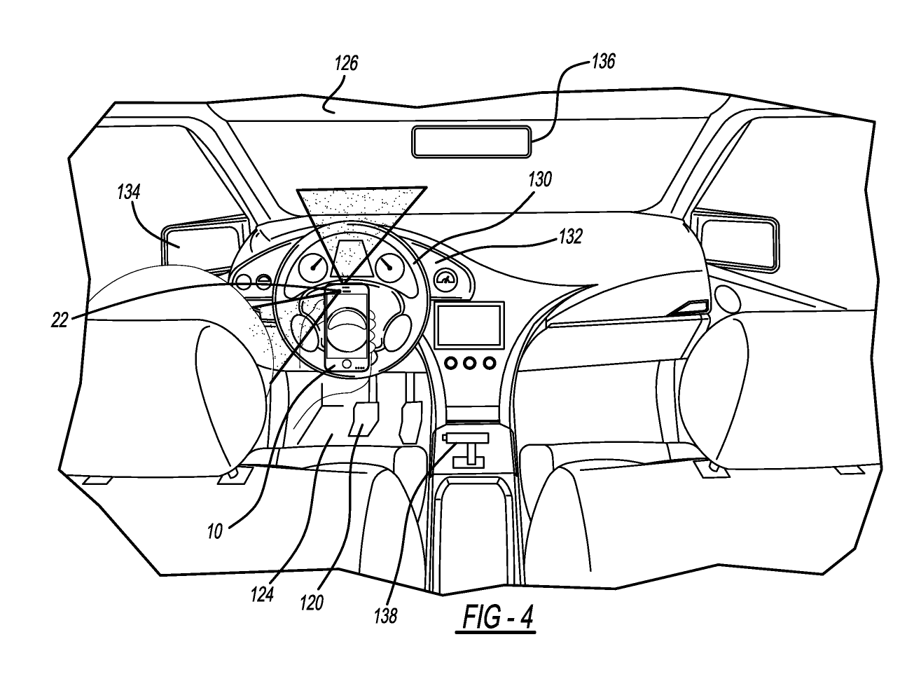

With reference to FIG. 4, if the user is holding the smart device 10 vertically such that the rear camera 20 is facing towards the front of the vehicle and the front camera 22 is facing the user or an area behind the user, the controller 12 can again compare the images sensed by the cameras 20 and 22 to stock images of various vehicles, or can analyze the images in any suitable manner to identify if the user is seated in the driver's seat, and thereby deemed to be a driver, or at some other position within the vehicle. Thus if the rear camera 20 captures one or more images unique to the driver's seat, such as a steering wheel 130 (such as the shape of the steering wheel 130 and/or a manufacturer logo on the steering wheel 130), dashboard 132 (including the instrument cluster for example), an exterior mirror 134 to the user's left, a rearview mirror to the user's right 136, a gear shifter 138 to the user's right, windshield angle, A-pillar location, etc., the controller 12 will determine that the smart device 10 is being used by a driver, particularly if the front camera 22 simultaneously captures the user's face and images unique to the driver's seat and/or behind the driver's seat

With reference to FIG. 5, the passenger cabin can include one or more machine readable codes or markers 150 at any suitable position. The markers 150 can be any suitable markers, such as QR codes or bar codes, which may be readily viewable or camouflaged in any suitable manner so that they are not readily visible to occupants. The markers 150 can be detected by the rear camera 20 and/or the front camera 22. Based on position of one or more of the markers 150 relative to the user, the controller 12 can determine whether the user is a driver. For example, if the rear camera 20 detects a first marker 150A and/or a second marker 150B to the user's left, a third marker 150C generally centered in front of the user, and/or a fourth marker 150D on the pedal 120, the controller 12 will determine that the user is a driver. If the marker 150E is detected as being in front of the user, the controller 12 will determine that the user is a passenger.

With continued reference to FIG. 5, the audio sensor 24 can also be used to determine if the user is a driver. For example, the vehicle can include a driver's side speaker 160A and a passenger's side speaker 160B, which can emit sound waves 162A and 162B respectively that are at different frequencies and inaudible to humans. The audio sensor 24 can receive the sound waves 162A and 162B, and based on the relative intensity of the sound waves 162A and 162B (or differences between the sound waves 162A and 162B that are not detectable by the human ear, such as differences in pitch of a tone inaudible to humans), the controller 12 can determine whether the smart device 10 is closer to the driver's side speaker 160A or the passenger's side speaker 160B. If the controller 12 determines that the smart device 10 is closer to the driver's side speaker 160A, then the controller 12 will determine that the user is a driver. Conversely, if the controller 12 determines that the smart device 10 is closer to the passenger's side speaker 160B, or another speaker not associated with the driver's seat, then the controller 12 will determine that the user is not a driver.

With further reference to FIG. 5, a display 170 can emit any suitable signal, image, display frame, or marker 172, which can be invisible to the naked eye, but visible to the rear camera 20 or the front camera 22. The display 170 can be any suitable display, such as any suitable dashboard display or center counsel display, configured with any suitable scanning rate. For example, the display 170 can have scanning rates of 240 Hz, 120 Hz, 75 Hz, 60 Hz, or 30 Hz, or any other suitable scanning rate. The rear camera 20 and the front camera 22 can also have any suitable scanning rates, such as scanning rates that are different from the display 170. The mismatch in scanning rates between the display 170 and the cameras 20 and/or 22 may appear as the marker 172 in the form of lines that move horizontally, vertically, and sometimes diagonally across the display 170 as detected by the rear and/or front cameras 20 and 22, and as potentially viewed by the user by way of the display 14 of the smart device 10, for example. The naked eye cannot see the marker 172 when directly viewing the display 170 however.

The present teachings provide for use of these mismatched scanning lines to display hidden markers 172 on the display 170 that the human eye is not fast enough to detect. The smart device 10 can find and detect these markers 172 by operating the rear and/or front cameras 20 and 22 at a scanning rate that does not match the scanning rate of the display 170. The controller 12 can use these markers 172 to determine the position of the smart device 10 within the vehicle. For example, if the display 170 is a dashboard display directly in front of the driver's seat and is configured to display the hidden markers 172, then upon detection of the markers 172 by the rear camera 20 in front of the user the controller 12 will determine that the user is a driver. If the display is a center counsel display 180 and the controller 12 detects the hidden markers 172 to a right of the user at the display 180, then the controller 12 will also determine that the user is a driver. But if for example the controller 12 detects the hidden markers to a left of the user, then the controller 12 will determine that the user is a passenger.

If the controller 12 determines that the user of the smart device 10 is a driver using any of the detection devices and/or methods described above, or any other suitable method or device, at block 116 the controller 12 will configure the smart device 10 to run mobile versions of applications. The mobile versions of the applications can vary in any suitable manner from regular versions of the applications in order to improve driver awareness, improve eyes-on-road behavior, and decrease distractions to the driver in any suitable manner. For example, the mobile versions have an enlarged font and/or typeface to improve legibility, lockout specific features that may be considered difficult to operate while driving, or provide for streamlined operation of the application in any suitable manner. Further, the controller 12 may restrict operation of one or more applications in their entirety when the user is driving.

The present teachings are not limited to use of cameras, such as the rear and front cameras 20 and 22, to detect whether the smart device 10 is in the possession of a driver of a vehicle. Any other suitable method or device (such as any suitable sensor) can be used to determine the location of the smart device within the vehicle, and optionally map the area around the driver. For example, any suitable device or method for tracking and/or identifying the location of the smart device 10 within a vehicle can be used, such as near field communication (NFC), an infrared (IR) detection device, or thermal imaging device, for example.

With respect to the IR detection device, it may be included with one or both of the cameras 20 and 22, and may be any suitable IR detection device, such as an IR camera. Using the cameras 20 and/or 22, and/or the IR detection device, the present teachings provide for creating a model of the vehicle's cockpit area, which can then be used to identify the location of the smart device 10 in the cockpit area, such as whether the smart device is at or proximate to the driver's seat and thus likely in possession of the driver.

With respect to the thermal imaging device, any suitable thermal imaging device can be used. The thermal imaging device can be included with the smart device 10, and/or can be separate from the smart device 10 but in communication with the smart device 10. Using the thermal imaging device, alone or in combination with the cameras 20 and 22, a heat footprint of the passenger cabin, surrounding portions of the vehicle, and/or persons within the passenger cabin can be analyzed to determine the location of the smart device 10 and its likely user. For example, if the thermal imaging device is pointed toward the front of the vehicle so that it can detect heat from the engine compartment and portions thereof directly in front of the user, the controller 12 will determine that the smart device 10 is likely in possession of the driver. The thermal profile of any other suitable landmarks of the vehicle, and/or even the passengers themselves, can be used to determine the location of the smart device in the vehicle.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A method for detecting possession of a smart device by a driver of a vehicle comprising:
detecting with the smart device at least one of a landmark or signal accessible from an interior of the vehicle;
analyzing the landmark or signal and the location of the smart device relative thereto to determine whether the smart device is at a driving location of the vehicle; and
configuring the smart device in a driving mode if the smart device is at the driving location of the vehicle.

2. The method of claim 1, further comprising detecting at least one of the landmark or signal with at least one of a front-facing or rear-facing camera of the smart device.

3. The method of claim 1, further comprising detecting at least one of the landmark or signal with a microphone of the device.

4. The method of claim 2, wherein the landmark includes a ceiling of the vehicle and a driver's side floor area of the vehicle.

5. The method of claim 2, wherein the landmark includes a rear of the vehicle and a dashboard area of the vehicle.

6. The method of claim 2, wherein the landmark includes a barcode.

7. The method of claim 2, wherein the signal includes a display marker of a dashboard display.

8. The method of claim 3, wherein the signal includes an audio signal from a speaker of the vehicle.

9. The method of claim 1, wherein the smart device is a smartphone.

10. The method of claim 1, further comprising detecting at least one of the landmark or signal with an infrared detection device.

11. The method of claim 1, further comprising detecting at least one of the landmark or signal with a thermal imaging device.

12. A system for detecting location of a smart device at a driving location of a vehicle comprising:
at least one sensor of the smart device configured to detect at least one of a landmark or signal accessible from an interior of the vehicle; and
a control unit configured to analyze the landmark or signal and identify location of the smart device relative thereto to determine whether the smart device is at the driving location of the vehicle;
wherein the smart device is configured to operate in a driving mode when the smart device is at the driving location of the vehicle.

13. The system of claim 12, wherein the sensor includes at least one of a front-facing camera or a rear-facing camera.

14. The system of claim 12, wherein the sensor includes a microphone.

15. The system of claim 12, wherein the landmark includes a ceiling of the vehicle and a driver's side floor area of the vehicle.

16. The system of claim 12, wherein the landmark includes a rear of the vehicle and a dashboard area of the vehicle.

17. The system of claim 12, wherein the landmark includes a machine readable code.

18. The system of claim 12, wherein the signal includes a marker of a dashboard display not visible to the naked eye.

19. The system of claim 12, wherein the signal includes an audio signal from a speaker of the vehicle.

20. The system of claim 12, wherein the detection device includes an infrared detection device, a thermal imaging device, and a visible light camera.
